(19) United States
(12) Patent Application Publication
(10) Pub. No.: US 2025/0153995 A1
(43) Pub. Date: May 15, 2025

(54) CARBONATION DEVICE

(71) Applicant: BREVILLE PTY LIMITED, Alexandria (AU)

(72) Inventors: Jonathan Mark Woodcock, Alexandria (AU); Gerard Andrew White, Alexandria (AU); Peter Conrad Darby, Alexandria (AU); Han Young Hwang, Alexandria (AU); Raymond George Corkin, Alexandria (AU)

(73) Assignee: BREVILLE PTY LIMITED, Alexandria (AU)

(21) Appl. No.: 18/840,218

(22) PCT Filed: Feb. 22, 2023
(86) PCT No.: PCT/AU2023/050122

§ 371 Date: Aug. 21, 2024

(30) Foreign Application Priority Data
Feb. 22, 2022 (AU) 2022900398

(51) Int. Cl. B67D 1/00; B01F 23/2361; B01F 23/237; B67D 1/08; B67D 1/12

(52) U.S. Cl. CPC B67D 1/0069; B01F 23/2361; B01F 23/237621; B67D 1/0801; B67D 1/125; B67D 2001/0812

(57) ABSTRACT

A carbonation device (100) for carbonating a beverage in a container (200), the carbonation device (100) comprising:
a head portion (114b) for sealably receiving a mouth portion (220) of the container (200), the head portion (114b) having an infuser (120) that is operable to inject carbon dioxide into the container (200) via the mouth (220) of the container (200); and
an engagement feature (173) with which the container (200) can be configured to securably locate the container (200) with respect to the head portion (114b) in:
   an injection configuration in which the mouth portion (220) of the container (200) is substantially sealed with respect to the infuser (120) so that the infuser (120) can inject carbon dioxide into the container (200) to carbonate the beverage in the container; and
   a depressurisation configuration in which the mouth portion (220) of the container (200) is partially unsealed with respect to the infuser (120) to allow for depressurization of the container (200).

### RELATED APPLICATIONS

The present application claims convention priority from Australian Provisional Patent Application No. 2022900398, the contents of which are incorporated herein in their entirety by reference thereto.

### FIELD

The present invention relates to a carbonation device and an engagement mechanism for a carbonation device.

### BACKGROUND

In one example of existing carbonation devices, a user attaches a bottle containing a beverage to be carbonated to the device. The device is then operated to carbonate the beverage in the bottle by injecting carbon dioxide into the bottle via an infuser. There is a large build up of pressure in the bottle during the injection process, which is dangerous as the build-up of pressure could cause the bottle to explode and/or the cause the bottle to uncontrollably launch from the carbonation device as the bottle is being detached from the device. Thereby, the existing carbonation devices have a risk of causing property damage and/or injury to the user.

### SUMMARY OF INVENTION

Preferred embodiments of the present invention seek to alleviate one or more of the problems described above and/or to at least provide the public with a useful choice.

An aspect of the present invention provides a carbonation assembly including: a container for containing beverage to be carbonated, the container having a mouth portion and an engagement feature; and a carbonation device including: a head portion for sealably receiving the mouth portion of the container, the head portion having an infuser that is operable to inject carbon dioxide into the container via the mouth of the container to carbonate the beverage in the container; and an engagement feature engageable with the engagement feature of the container to securably locate the container with respect to the head portion in: (1) an injection configuration in which the mouth portion of the container is substantially sealed with respect to the infuser so that the infuser can inject carbon dioxide into the container to carbonate the beverage in the container; and (2) a depressurisation configuration in which the mouth portion of the container is partially unsealed with respect to the infuser to allow for depressurization of the container.

An aspect of the present invention provides a carbonation device for carbonating a beverage in a container, the carbonation device comprising: a head portion for sealably receiving a mouth portion of the container, the head portion having an infuser that is operable to inject carbon dioxide into the container via the mouth of the container; and an engagement feature with which the container can be configured to securably locate the container with respect to the head portion in: (1) an injection configuration in which the mouth portion of the container is substantially sealed with respect to the infuser so that the infuser can inject carbon dioxide into the container to carbonate the beverage in the container; and (2) a depressurisation configuration in which the mouth portion of the container is partially unsealed with respect to the infuser to allow for depressurization of the container.

In one embodiment, the engagement feature of the carbonation device includes at least one track portion that is engageable by a respective lug of the container, the track portion including: a first trapping portion that corresponds to the injection configuration when the respective lug of the container is located therein; and a second trapping portion that corresponds to the depressurisation configuration when the respective lug of the container is located therein. The engagement feature may include two or more track portions that are radially spaced apart from each other. In another embodiment, the engagement feature of the carbonation device includes at least one lug that is engageable by a respective track portion of the container, the track portion including: a first trapping portion that corresponds to the injection configuration when the respective lug of the container is located therein; and a second trapping portion that corresponds to the depressurisation configuration when the respective lug of the container is located therein.

The first trapping portion preferably has a higher elevation compared to the second trapping portion with respect to the head portion. In this example, each of the first trapping portion and the second trapping portion has a respective base portion on which the lug is restable when in the respective injection configuration or the depressurisation configuration, and the base portion of the first trapping portion has a higher elevation then the base portion of the second trapping portion.

The first trapping portion and the second trapping portion respectively preferably includes a crevice or valley portion in which the lug is trappable.

At least one of the first trapping portion and the second trapping portion may have at least one bearing surface against which the lug bears when in the respective injection or depressurisation configuration. The bearing surface may be a vertically upright wall portion. In one example, only the second trapping portion has a bearing surface. In another example, only the first trapping portion has a bearing surface. In yet another example, both the first and second trapping portions have respective bearing surfaces.

The carbonation device preferably includes a collar for embracing a neck of the container, the collar including the engagement feature. The infuser of the head portion preferably passes through a space defined by the collar. The infuser preferably passes centrally through the collar. The collar may include at least one channel leading to the engagement feature, wherein the neck portion of the container has a lug that is insertable into, and removable from, the engagement feature via the channel.

Another aspect of the present invention provides a container for use with the carbonation device of the aspect described previously above.

The container preferably includes at least one lug for engaging the engagement feature of the carbonation device. For example, the container includes a neck portion, and the at least one lug extends outwardly from the neck portion of the container. Preferably, the container includes two or more lugs that are radially spaced apart from each other around the neck portion of the container. The at least one lug may have a hexagon or a diamond-shaped cross-sectional profile.

A further aspect of the present invention provides a carbonation device for carbonating a beverage in a container, the carbonation device comprising: a head portion communicable with a mouth portion of the container, the head portion being adjustable between a first position and a second position; an infuser device having a switch that is selectively activatable to release carbon dioxide for injection into the container via the head portion; a handle that is operable by a user for activating the switch of the infuser device; and a linkage linking the head portion with the switch, wherein the linkage device is configurable in (1) a first configuration, when the head portion is in the first position, in which operation of the handle activates the switch to carbonate the beverage in the container; and (2) a second configuration, when the head portion is in the second position, in which operation of the handle does not activate the switch.

The head portion may be tiltable between the first position to the second position by an angle of at least 5°, or at least 10°, or at least 20°, or up to about 30°, or up to about 40°, or up to about 50°, or preferably about 26°. Preferably, the angle is about 30°+10°. Preferably, the head portion is tiltable from the first position, being a substantially vertically upright position, to the second position by said angle.

The head portion may include a tab portion that is manipulatable by a user to adjust the head portion from the first position to the second position and/or from the second position to the first position.

The handle preferably has a first portion defining a first pivot point about which the handle is pivotable when the head portion is in the first position and a second portion defining a second pivot point about which the handle is pivotable when the head portion is in the second position. When the handle pivots about the second portion, the first portion preferably moves from a first position to a second position. On the other hand, when the handle pivots about the first portion the second portion actuates the linkage to actuate the switch. The first portion may be moveable between the first position and the second position in a slot, the slot having a first channel portion for receiving the first portion in the first position, a second channel portion for receiving the first portion in the second position, and an intermediate channel portion between the first and second channel portions defining a narrow passage to trap the first portion in the first channel portion. The slot may be a kidney-bean shaped slot for example.

The carbonation device may further include at least one safety pressure valve that is configured to activate to release pressure in the container when a detected pressure in the container during carbonation exceeds a threshold pressure value.

In an embodiment, the linkage preferably includes a piston portion that is moveable upon operation of the handle. In this embodiment, the head portion may include an engagement feature that is engageable with the piston portion of the linkage only when the head portion is in the first position and the handle is operated; and the engagement of the piston portion with the engagement feature of the head portion allows for activation of the switch.

The linkage preferably includes: a first link portion pivotable about a third pivot point, pivotably connected to the piston portion and pivotably connected at the second pivot point to the handle; a second link portion connected to the second pivot point; and a third link portion pivotably connected at a fourth pivot point to the second link portion and having a fifth pivot point about which the third link portion is pivotable, the third link portion having an actuation portion for activating the switch of the infuser; wherein operation of the handle when the piston portion is aligned with the engagement feature causes the handle to pivot about the first pivot point and the second link portion to pivot about the third pivot point, which causes a translational movement of the second link portion, which in turn causes the third link portion to pivot about the fifth pivot point to cause the actuation portion of the third link portion to active the switch, and wherein operation of the handle when the piston portion is not aligned with the engagement feature causes the handle to pivot about the second pivot point and the second link portion to remain stationary such that the switch is not activated by the actuation portion.

The linkage may include: a fourth link portion having a portion that abuts the handle and being pivotable about a sixth pivot point, the fourth link portion being biased to return to a rest position; wherein operation of the handle when the piston portion is not aligned with the engagement feature causes: the handle to push against the fourth link portion thereby displacing it from its rest position such that the handle and sixth portion move in unison about their respective first and sixth pivot points; and when the handle is released, biasing acting on the fourth link portion returns the fourth link portion to its rest position which returns the handle to an off position. For example, the linkage includes a spring for returning the fourth link portion to the rest position.

In a preferred embodiment, the first position corresponds to a position in which the container is held by the head portion in a substantially vertically upright position.

Preferably, the linkage includes a transmission member, the transmission member having a protrusion adapted to, when the linkage is in the first configuration, be positioned in a gap between the handle and the switch such that operation of the handle activates the switch, and, when the linkage is in the second configuration, be positioned outside the gap between the handle and the switch such that operation of the handle does not activate the switch.

Preferably, the transmission member has a body, and the protrusion is pivotally mounted to the body, such that an angle between the protrusion and the body changes between the first and second configuration of the linkage.

Preferably, the protrusion is biased toward the handle such that when the linkage is moved from the second configuration to the first configuration, the protrusion remains in sliding contact with the handle during the movement.

Preferably, the transmission member has a body, and the body includes a first member and a second member, the first and second members being pivotally connected using a pivot, and the linkage connects to the body at the pivot, such that if motion of the linkage is resisted by the transmission member, the first and second members are movable about the pivot to allow the linkage to complete the motion.

Preferably, the first and second members are biased towards a rest state such that, once the resistance of the transmission member to the motion of the linkage is removed, the first and second members revert to the rest state.

Preferably, the rest state is configured such that, when the linkage is in the first configuration, the protrusion is positioned in the gap between the handle and the switch.

Preferably, the carbonation device further includes a positional safety mechanism, the positional safety mechanism including:
a tab protruding from a foot portion of the carbonation device such that, when the carbonation device is position with the foot portion on a surface, the tab moves from a blocking position to a safe position;
a blocking member moveable between a blocking position, wherein the handle is not operable to activate the switch, and a safe position, wherein the handle is operable to activate the switch;
a second linkage to link the tab with the blocking member such that:
when the tab is in the blocking position, the blocking member is in the blocking position, and
when the tab is in the safe position, the blocking member is in the safe position.

Preferably, the blocking member is mounted using a pivot and includes a first arm extending from the pivot adapted to, in the blocking position, block movement of the handle toward the switch.

Preferably, the first arm includes a recess to allow the protrusion of the transmission member to be positioned in the gap between the handle and the switch.

Preferably, the blocking member includes a second arm extending from the pivot at an angle to the first arm, the second arm being connected to the second linkage to pivotally move the blocking member between the blocking and safe positions.

Preferably, the blocking member is biased toward the blocking position.

In another aspect, the present invention provides a container to contain a beverage to be carbonated with the carbonation device of a previous aspect, the container having a mouth portion and an engagement feature.

Preferably, the container includes at least one lug for engaging the engagement feature of the carbonation device.

### BRIEF DESCRIPTION OF DRAWINGS

Preferred embodiments of the invention will now be described by way of non-limiting example only with reference to the accompanying drawings, in which:

FIG. 1A shows a perspective exploded view of a carbonation assembly according to an embodiment of the present invention;

FIG. 1B shows a sectional side view of the carbonation assembly according to an embodiment of the present invention;

FIG. 2 shows a detailed perspective exploded view of view of the tilt head, engagement feature, and skirt of the carbonation device according to an embodiment of the present invention;

FIG. 3 shows a perspective view of the skirt of the carbonation device according to an embodiment of the present invention;

FIGS. 4A to 4E show an embodiment of an engagement feature of the carbonation device according to an embodiment of the present invention;

FIG. 5A to 5F show the linkage of the carbonation device according to an embodiment of the present invention;

FIGS. 6A and 6B show the linkage of the carbonation device according to an embodiment of the present invention with the tilt head in a first position; and

FIGS. 7A and 7B show the linkage of the carbonation device according to an embodiment of the present invention with the tilt head in a second position.

FIG. 8 is an exploded view of a carbonation device according to a second embodiment of the invention.

FIG. 9 is a cut-away isometric view of the carbonation device of FIG. 8.

FIG. 10 is a section view of the carbonation device of FIG. 8 with the head portion in the second position and the positional safety mechanism in the blocking position.

FIG. 11 is a section view of the carbonation device of FIG. 8 with the head portion in the second position and the positional safety mechanism in the safe position.

FIG. 12 is a detailed section view of the carbonation device of FIG. 11, where the handle is attempted to be operated.

FIG. 13 is a cut-away isometric view of the carbonation device of FIG. 8 with the head portion in the first position and the positional safety mechanism in the safe position.

FIG. 14 is a detailed section view of the carbonation device of FIG. 13.

FIG. 15 is a detailed section view of the carbonation device of FIG. 13, with the handle being operated.

FIG. 16 is a detailed section view of the carbonation device of FIG. 11, with the head portion being moved from the second position to the first position while the handle is being held.

FIG. 17 is a detailed section view of the carbonation device of FIG. 16, after the head portion has completed its motion to the first position with the handle being held.

### DESCRIPTION OF EMBODIMENTS

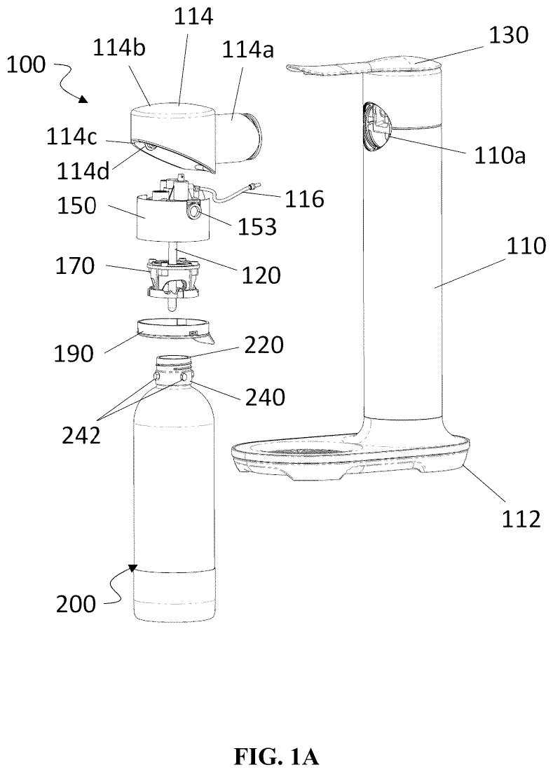

FIGS. 1A and 1B show a carbonation assembly according to an embodiment of the present invention. The carbonation assembly includes a carbonation device 100 and a container 200 for containing a beverage. The container 200 is preferably in the form of a bottle. The container 200 is specifically configured and/or adapted for use with the carbonation device 100. In particular, the container 200 has engagement features that are engageable with the carbonation device 100 to securely locate the container 200 with respect to the carbonation device 100. The carbonation device 100 is operable, by a user, to carbonate the beverage contained in the container 200 when the container 200 is secured to the carbonation device 100 and is in a ready orientation.

The carbonation device 100 includes an enclosure (or tower housing) 110 that stores a cannister 300 (shown in FIG. 1B) containing carbon dioxide (CO₂). The cannister 300 may be referred to as an infuser device 300. The enclosure 110 is in the form of a cylindrical housing extending upwardly from a base (or foot) 112. The cannister 300 is removable from the enclosure 110 and replaceable with another cannister that is compatible with the carbonation device 100. The enclosure 110 also houses a linkage 160 (or a clutch mechanism; which will be described in further detail below) that is configurable to control a release of carbon dioxide from the cannister 300 for carbonating the beverage in the container 200. In particular, the linkage is configured to enable an operation of the carbonation device 100 to carbonate the beverage in the container 200 when the container 200 is held by the carbonation device 100 in a ready (or carbonation-enabled) orientation and is configured to disable the operation of the carbonation device 100 to carbonate the beverage when the container 200 is held by the carbonation device 100 in a loading (or a carbonation-disabled) orientation. In preferred embodiments, the ‘ready (or carbonation-enabled) orientation’ is an orientation in which the container is substantially upright, while the ‘loading (or carbonation-disabled) orientation’ is an orientation in which the container is tilted, which would be desirable when loading (or inserting) or unloading (or removing) the container to or from the carbonation assembly but not desirable when the beverage in the container is being carbonated.

The carbonation device 100 includes a handle 130 that is provided at a top of the enclosure 110. The handle 130 according to the preferred embodiment shown in FIGS. 1A and 1B is in the form of a lever that is pivotable relative to the enclosure. The handle 130 is pivotably coupled to the enclosure 110. In other examples, the handle may be in the form of a rotatable knob or a switch that is actuatable to activate the carbonation device when the container is in the ready orientation. A user can operate the handle 130 by pivoting the handle 130 relative to the enclosure 110 (e.g. pivoting the handle 130 downwardly) between a first handle position and a second handle position. The first handle position corresponds to an ‘off’ position, while the second handle position corresponds to an ‘on’ position or a ‘fully on’ position. In this regard, it should be appreciated that a supply rate of carbon dioxide from the cannister 300 to the container 200 can be adjusted by adjusting the handle between the first and second handle positions. That is, a range of positions of the handle 130 between the first handle position and the second handle position corresponds to a ‘partially on’ position. As will be described below, although the handle 130 may be moved to the ‘on’ position, the carbonation device 100 would be disabled or non-operative for carbonation if the container 200 is in the loading orientation. The carbonation device 100 would only carbonate a beverage in the container 200 if the container 200 is in the ready orientation and the handle is moved to the ‘on’ position.

The handle 130 is selectively pivotable about a first pivot axis or a second pivot axis depending on whether the container 200 is in the ready orientation or the loading orientation as previously described. When the container 200 is in the ready orientation, the handle 130 would pivot about the first pivot axis upon operation of the handle 130. When the container 200 is in the loading orientation, the handle 130 would instead pivot about the second pivot axis upon operation of the handle 130.

The handle 130 has a first portion about which the handle 130 is pivotable about the first pivot axis and a second portion about which the handle 130 is pivotable about the second pivot axis. In this regard, the handle 130 has a lever portion (or duck member) 132 that can be manipulated by the user and a finger member (projection or tongue) 134 extending from the lever portion 132, the finger member 134 being locatable in the enclosure 110 and including the first and second portions. The first and second portions may be integral with finger member 134 or may be part of one or more separate components that are attached or coupled to the finger member. For example, the first and/or second portions may be part of the linkage that is connected or connectable to the handle. In a preferred embodiment, the lever portion is mateable with the finger member. For example, the lever may be insertable into a pocket of the finger member. The finger member 134 is pivotably coupled at the first portion to the enclosure 110 and pivotably coupled at the second portion to the linkage in the enclosure 110. The first portion is closer to the lever portion 132 than the second portion. The enclosure 110 has a slot along which said first portion of the handle 130 is moveable between a first position and a second position when the handle 130 pivots about the second pivot axis. The slot has a first channel portion for receiving the first portion of the handle 130 when in the first position, a second channel portion for receiving the first portion of the handle 130 when in the second position, and an intermediate channel portion between the first and second channel portions defining a narrow passage to trap the first portion of the handle 130 in the first channel portion such that the first portion would only be able to escape the first channel portion via the intermediate passage when a sufficient force is applied to the first portion upon actuation of the handle 130. This sufficient force corresponds to a force that would be applied when the handle 130 is operated and when the second portion of the handle 130 is fixed, such that the handle 130 pivots about the second portion. In the preferred example, the slot is a kidney-bean shaped slot. In other examples, the slot is an arcuate or curved slot. In these other examples, the slot may have a uniform or non-uniform passage for the first portion of the handle between the first channel portion and the second channel portion. In the preferred example, the second portion of the handle 130 is pivotably coupled to a portion of the linkage via a ball-and-socket configuration. The first portion of the handle 130 is normally in the first location, which corresponds to the handle 130 being in the ‘off’ position.

When the container 200 is in the ready orientation, operation of the handle 130 would cause the handle 130 to pivot about the first portion in its respective first position and cause the second portion, which is free to move relative to the enclosure, to actuate the linkage to activate a valve of the cannister 300 in the housing to release CO₂ to carbonate the beverage in the container 200. Thereby, any load applied to the handle 130 when the container 200 is in the ready orientation results in a pivoting motion of the handle 130 about the first pivot axis and activation of the carbonation device 100.

On the other hand, when the container 200 is in the loading orientation, operation of the handle 130 would cause the handle 130 to pivot about the second portion, which urges the first portion of the handle 130 to move, along the slot, from the first position to the second position. In this configuration, the second portion of the handle 130 is locked (or fixed in place) relative to the enclosure 110 such that operation of the handle 130 does not result in actuation of the linkage to activate the valve of the cannister 300. Thereby, any load applied to the handle 130 when the container 200 is in the loading orientation results a pivoting motion of the handle 130 about the second axis and results in the first portion of the handle 130 moving from the first position to the second position and the carbonation device 100 being disabled/deactivated for beverage carbonation.

The lever portion 132 of the handle 130 has a length such that a free end of the lever portion 132 is locatable above a head portion 114b of a spout portion 114 of the carbonation device as will be described in further detail below. In the second handle position (or the ‘on’ position or ‘fully on’ position), the free end of the lever portion 132 touches the head portion 114b of the spout portion 114. A range of pivoting movement of the handle 130 is thereby limited by the spout portion 114. A travel distance of the first portion of the handle 130 from the first position to the second position, as previously described above, corresponds to a travel distance of the free end of the lever portion 132 to the spout portion 114. In particular, when the container 200 is in the loading orientation and the handle 130 is operated, the first portion of the handle 130 at its respective second location corresponds to the tip of the lever portion 132 touching the spout portion 114. In this way, by limiting the range of pivoting motion of the lever portion 132 by the spout portion 114, the internal mechanisms of the carbonation device would be protected from mechanical failure when the container is in an ready orientation and the handle 130 is operated. Any further force that is applied onto the handle 130 when the tip of the handle 130 already contacts the spout portion 114 would be resisted by the spout portion 114 and isolated the internal mechanics of the carbonation device. If the pivoting motion of the lever portion 132 is not limited, the lever portion 132 could be operated to an extent that excessive loads would be applied on the first portion of the handle 130 and/or on the second portion of the handle 130 and/or on the linkage to which the second portion of the handle 130 is pivotably coupled, resulting in one or more mechanical failures of the carbonation device 100. In other examples, the operation range of the lever could be limited by other features of the carbonation assembly such as an external face of the enclosure or by one or more stop members in the enclosure.

The handle 130 is biased to the ‘off position’. In particular, when the user releases the handle 130 from the ‘on position’ or the ‘partially on’ position, a biasing (e.g. a spring) returns the handle 130 to the ‘off position’. In other examples, the user may manually return the handle to the ‘off position’. In the ‘off position’ the handle extends substantially horizontally, i.e. perpendicularly relative to the enclosure. In an alternative preferred embodiment, the handle 130 stays in the ‘on’ position when moved thereto by the user and automatically returns to the off position when the carbonation of the beverage is complete. In this regard, the carbonation device may include one or more sensors (such as pressure sensors) and/or one or more timers that are used to determine when a carbonation process is complete.

The enclosure 110 includes an aperture 110a to which a spout portion 114 is attached. In some examples, the spout portion 114 may be removably attached to the housing 110. In other examples the spout portion 114 may be fixedly attached to, or integrally formed with, the housing 110. The spout portion 114 includes a shaft portion 114a that attaches to the enclosure 110 and a head portion 114b. The shaft portion 114a includes a channel or passageway for receiving an infusion line (or CO₂ line) 116 that is fluidly connected to the cannister 300 in the enclosure 110. The infusion line leads to an infuser 120 that is positionable in the container 200 for injecting CO₂ from the cannister 300, when activated, into the beverage in the container 200 to thereby carbonate the beverage. The shaft portion 114a additionally includes or houses portions of the linkage, which will be described in further detail below.

The head portion 114b has a generally truncated cylindrical body with the truncated (or tapered) section facing downwards. The head portion 114b includes a mouth portion 114c for receiving the container 200. The mouth portion 114c faces the base 112 of the enclosure 110. The mouth portion 114c is located on a truncated section of the head portion 114b. The angle of the tapered surface of the head portion 114b relates to a range of tiltability of the bottle when it is received by the mouth portion 114c. The head portion 114b has two projections 114d located on an inner wall of the head portion 114b. The two projections 114d are diametrically spaced apart from each other, i.e. are on opposite sides, within the head portion 114b.

The mouth portion 114c pivotably receives a tilt head 150. In this regard, the tilt head 150 includes two recesses 153 into which the projections 114d on the inner wall of the head portion 114b are respectively locatable to thereby allow the tilt head 150 to tilt relative to the head portion 114. The tilt head 150 is tiltable between a first tilt head position to a second tilt head position by an angle of about 26°. In other examples, the tilt head may have a tilt range of at least about 5°, at least about 10°, or at least about 20°, or up to about 30°, or up to about 40°, or up to about 50° In the preferred embodiment, the first tilt head position is a substantially vertically upright position that corresponds to the ready orientation for the container as previously described above. The tilt head 150 further includes a sealing portion in the form of a tapered washer 159 through which the infuser 120 passes and for substantially sealing an opening of the container to allow for carbonation of the beverage in the container 200. In particular, the tapered washer 159 seals that container 200 to allow for high pressure conditions to be achieved within the container 200 during the carbonation process that are required to carbonate the beverage. The seal between the tapered waster 159 and the mouth of the container 200 is provided when the container 200 is urged or presses against the tapered washer 159. In this regard, the tapered washer 159 is made from a resiliently deformable material and has tapered walls that are locatable within the container 200. The tapered shape of the washer 159 allows for a suitable seal to be formed with the container 200 for safe carbonation and for safe depressurization. In other examples, the sealing portion may be a seal having another suitable shape for sealing the mouth portion of the container.

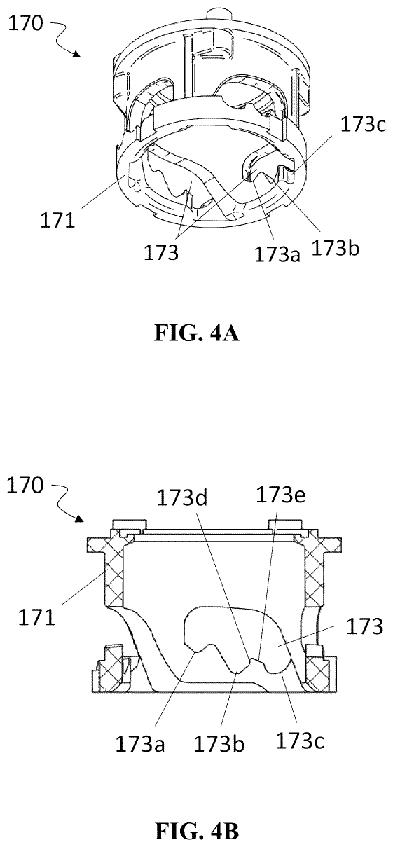

The carbonation device 100 further includes a locking (or securing) head 170 for securing the container 200 to the tilt head 150 in one of a plurality of configurations. The locking head 170 is in the form of a collar that receives a neck of the container 200. In this regard, the container 200 can be secured to the locking head 170 in an injection configuration in which a mouth of the container 200 is substantially sealed by the tapered washer 159 with the infuser 120 being located in the container 200 for injecting CO₂ into the container 200 to carbonate the beverage. The container 200 can also be secured to the tilt head 150 in a depressurisation configuration in which the container 200 is partially unsealed, or partially dislodged, with respect to the tapered washer 159, while still being held securely in place relative to the locking head 170, to allow for the container 200 to be depressurised safely following carbonation. The locking head 170 will be described in further detail with reference to FIGS. 4A to 4E.

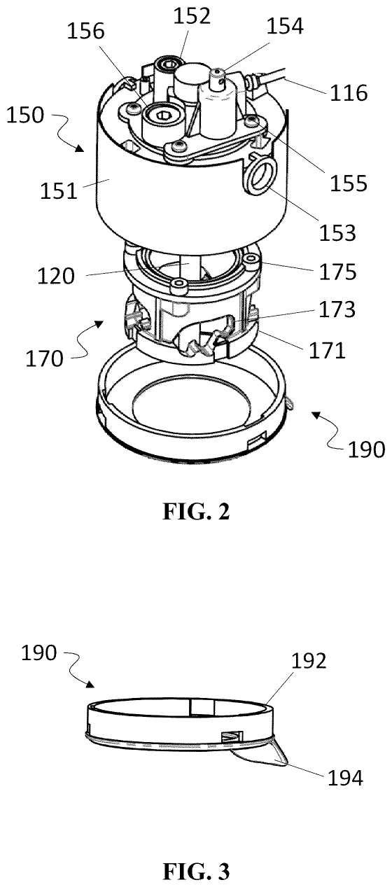

The carbonation device 100 also includes a skirt 190 that attaches to the tilt head 150 such that the locking head 170 is enclosed by the tilt head 150 and the skirt 190. With reference to FIG. 3, the skirt 190 has a ring- or annular-shaped body 192 with a tab portion 194 extending outwardly from the body 192. The tab portion 194 enables the user to easily tilt the tilt head. In particular, a user can intuitively locate a finger on the tab portion 194, that would be normally rearwardly located in the carbonation device 100, and pull or push on the tab portion 194 to tilt the tilt head 150 to which the skirt 190 with the tab portion 194 is secured. For example, when a user desires to secure the container 200 to the carbonation device, the user manipulates the tab portion 194 of the skirt 190 with one hand to tilt the tilt head 150 to face outwardly and uses the other hand to locate the mouth of the container into the tilt head 150. Thereafter, the user can push the container 200 so that it is substantially vertically upright following which the carbonation device can be activated to carbonate the beverage in the container. Once the carbonation process is complete and the container has been safely depressurised, the user can again manipulate the tab portion 194 of the skirt 190 with one hand to tilt the tilt head 150 to face outwardly and use the other hand to remove the container from the tilt head 150.

Returning back to FIG. 1A, the container 200 has a mouth portion 220 and a neck portion 240 that leads to the mouth portion 220. The container 200 is an elongate body, which in a preferred embodiment is a cylindrical body, having a height along a central longitudinal axis. The neck portion 240 includes a plurality of engagement portions 242 that are engageable with the locking head 170 to secure the container 200 thereto. In the embodiment shown in FIG. 1A, the neck portion 240 has four spaced-apart engagement portions 242. The engagement portions are radially spaced apart about the central longitudinal axis. Where the neck portion 240 has four engagement portions 242, an angle between neighbouring engagement portions 242 is about 90° (being 360°/4). In other examples, the neck portion of the container may include n number engagement portions, n being an integer greater than 1, and the angle between neighbouring engagement portions is about 360°/n. For example, the neck portion of the container may have two, three, or more than four engagement portions. The equal spacing between neighouring engagement portions 242 allows for the bottle 200 to be inserted into the locking head 170 in any one of a plurality (n) of orientations about the central longitudinal axis through the container 200. The engagement portions 242 are lugs for respectively engaging engagement features of the locking head 170. Each lug has a hexagon or a diamond-shaped cross-sectional profile. In other example, each lug may have other sectional profiles. For example the lug may have a triangular, square, pentagon or other polygon sectional profile. Preferably, at least one side of the lug has a straight/flat edge for securely bracing against an edge of the locking head. In another example, the lug may have a circular-, oval- or curved-shaped cross-sectional area.

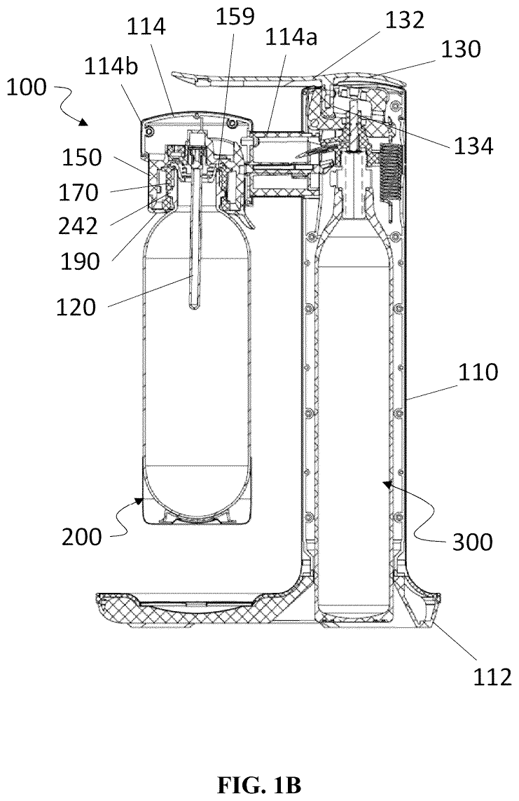

Referring to FIG. 2, the tilt head 150 is a housing (or a cap) in which the locking head 170 is securely receivable. A top surface of the tilt head 150 has a plurality of apertures 155 that are aligned with corresponding apertures in the locking head 170. The apertures 155 in the tilt head 150 are provided in frame members on the tilt head 150. Fasteners are fastenable into respective aligned apertures 155, 175 of the tilt head 150 and the locking head 170 to thereby secure the locking head 170 to the tilt head 150. Once secured, the locking head 170 cannot rotate or move relative to the tilt head 150. Thereby, the locking head 170 remains substantially stationary when the user inserts the mouth portion of the container into the locking head 170 and twists the container to secure the container relative to the locking head 170. The locking head 170 moves in unison with the tilt head 150 when the tilt head is tilted between the first tilt head position and the second tilt head position. As previously described, the skirt 190 encloses the locking head 170 in the tilt head 150. In other examples, the locking head is integrally formed with the tilt head as a single unit. Additionally or in yet further examples, the skirt may be integrally formed with the tilt head and/or the locking head.

When securing the container 200 to the locking head 170, the container 200 can be twisted into the locking head 170 in an injection configuration in which the mouth of the container 200 is substantially sealed relative to the tapered washer 159 of the tilt head 150 with the infuser 120 extending into an interior volume of the container 200. The infuser 120 passes through a space defined by the locking head 170. The infuser 120 preferably passes centrally through the locking head 170 and into the container 200. As previously described, an infusion line 116 leads to the infuser 120 for delivering CO₂ from the cannister 300 in the housing of the carbonation device 100 to the container 200 to thereby carbonate the beverage in the container 300. When the container 200 is in the injection configuration and CO₂ is injected into the container 200, there would be a pressure build up in the container. The tilt head 150 includes safety pressure valves 152, 154, 156 that are respectively actuatable to release pressure in the container 200 during the carbonation process to prevent an excessive build up of pressure in the container during the carbonation process. These valves are pressure release valves. When the pressure in the container 200 exceeds a respective pressure threshold value, a respective one of the safety pressure valves 152, 154, 156 assumes an open configuration from a normally closed configuration to partially unseal a connection between the tapered washer 159 and the mouth portion of the container 200 thereby releasing pressure from the container 200. While the pressure is below or once the pressure drops below the respective pressure threshold value, the respective pressure release valve stays or returns to the closed configuration to seal the connection between the tapered washer and the mouth portion of the container 200 so that the carbonation process can be performed. The safety pressure valves 152, 154, 156 are configured to activate to release pressure at respective pressure threshold values. In particular, a first safety valve 152 is configured for operation at a threshold pressure value of about 4 to 6 bar, a second safety valve 154 is configured for operation at a threshold pressure value of about 5 to 9 bar, and a third safety valve 156 is configured for a threshold pressure of about 10 to 12 bar. The first valve allows for pressure to be discharged when a pressure within the container exceeds the associated threshold pressure value. The second pressure valve 154 can be actuated by a cam upon bottle tilt for selectively releasing pressure within the container. The third pressure release valve 156 is a final safety measure if the other valves fail. The third valve 156 is a membrane-based burst disk (analogous to electrical fuse, in that the valve would need to be replaced once activated). Alternatively, the third valve may be a spring resettable valve. Over the associated pressure threshold value, the third valve 156 bursts to release the pressure in the container 200. In other examples, the tilt head may have pressure safety valves that are respectively configured for operation at different threshold values, and/or may have one, two, or more than three pressure safety valves.

FIGS. 4A to 4E show views of the locking head 170 of the carbonation device previously described above. FIGS. 4B to 4E show sectional views with the engagement portion 242 of the container 200 located in the locking head 170.

The locking head 170 has an engagement feature 173 with which the container 200 can be configured to securably locate the container 200 with respect to the locking head 170. In this regard, the engagement portions 242 of the container 200, that were previously described above, are engageable with the engagement feature 173 of the locking head 170 in one of two of configurations to secure the container 200 to the locking head 170. The first configuration is an injection configuration in which the mouth portion 220 of the container 200 is substantially sealed with respect to the tilt head 150 with the infuser projecting into the container 200 for injecting carbon dioxide into the container to carbonate the beverage in the container 200, as shown in FIG. 4D. In this configuration, the mouth portion 220 of the container 200 is urged against the tapered washer 159 to form a seal therebetween for the safe carbonation of the beverage in the container 200. The second configuration is a depressurisation configuration in which the mouth portion 220 of the container 200 is partially unsealed, or partially dislodged, with respect to the infuser to allow for depressurization of the container, as shown in FIG. 4E, while still being secured to the locking head 170 to thereby prevent all of the built-up pressure in the container from escaping the container immediately that would cause the container from uncontrollably launching from the carbonation device during depressurisation. In this configuration, the mouth portion 220 of the container 200 is partially unsealed or partially spaced apart from the tapered washer 159 to allow for a safe depressurization of the container 200. In particular, by having the mouth portion 220 of the container 200 partially unsealed, the pressure would be allowed to escape the container slowly when the container is in the depressurisation configuration. FIG. 4C shows a transition of the engagement feature between the injection configuration (shown in FIG. 4D) and the depressurisation configuration (shown in FIG. 4E).

The engagement feature 173 of the locking head 170 includes track portions that are each engageable by a respective engagement portion 242 of the container 200. In particular, a number of track portions of the engagement feature 173 is the same as the amount of engagement portions 242 provided on the container 200. In this preferred embodiment, the engagement feature 173 has four track portions that are respectively engageable by the four engagement portions 242 of the container 200. In other examples, the engagement feature may have two, three, or more than four track portions. The track portions are radially spaced apart from each other about a central axis through the locking head 170. In a variation, the track portions may be provided on the container and the lugs (or projections) may be provided on the locking head 170.

With reference to FIGS. 4B to 4E, each track portion 173 includes a first trapping portion 173a that corresponds to the injection configuration when the respective engagement portion 242 of the container 200 is located therein; and a second trapping portion 173b that corresponds to the depressurisation configuration when the respective engagement portion 242 of the container 200 is located therein.

The first trapping portion 173a and the second trapping portion 173b respectively includes a crevice or valley portion in which the engagement portion 242 is trappable. In addition, the second trapping portion 173b has an upright surface 173d against which the engagement portion 242 of the container 200 can bear when in the depressurisation configuration. The upright surface 173d is a vertically upright wall portion. In another example, the first trapping portion may also have such an upright surface. The upright surface 173d additionally or alternatively acts as a catch. When the engagement portion 242 is located in the second trapping portion 173b, the upright surface 173d is high enough to ‘catch’ and abort the inertia of the engagement portion 242. In particular, the upright surface 173d is sufficiently high to trap the engagement portion 242 in the second trapping portion 173b to thereby prevent the engagement portion 242 from escaping the trapping portion 173d due to inertia during depressurization and sliding over the upright surface 173b and out of the channel 173c.

The first trapping portion 173a has a higher elevation compared to the second trapping portion 173b. These different elevations correspond to respective different locations of the mouth portion of the container with respect to the sealing portion of the tilt head. In this regard, each of the first trapping portion 173a and the second trapping portion 173b has a respective base portion on which the engagement portion 242 is restable when in the respective injection configuration or the depressurisation configuration. The base portion of the first trapping portion 173a has a higher elevation then the base portion of the second trapping portion 173b. The base portion corresponds to the lowermost region of the crevice or valley portion previously described. Thereby, when the engagement portion 242 is in the first trapping portion 173a as shown in FIG. 4D, the mouth portion 220 of the container 200 is closer to a scaling portion, i.e. the tapered washer 159, of the tilt head compared to when the engagement portion 242 is in the second trapping portion 173b as shown in FIG. 4E. In particular, when the engagement portion 242 is in the first trapping portion 173a as shown in FIG. 4D, the mouth portion 220 of the container 200 is substantially sealed by the sealing portion 159 of the tilt head so that the beverage contained in the container 200 can be carbonated. When the engagement portion 242 of the container 200 is in the second trapping portion 173b as shown in FIG. 4E, the mouth portion 220 of the container 200 is partially unsealed with respect to the sealing portion 159 to allow for a depressurisation of the container 200.

The engagement between the container 200 and the locking head 170 consists multiple points of contacts that surrounds the neck portion of the container 200 at discrete points. These multiple points of contact are distributed uniformly about the container 200. In particular, the container has a plurality of radially spaced apart engagement portions for engaging a plurality of radially spaced apart track portions. The multiple points of contact between the container 200 and the locking head 170 allow for the container 200 to be securely and uniformly held by the locking head 170 during the beverage-carbonation process (when the engagement is in the configuration shown in FIG. 4D) and the container-depressurisation process (when the engagement is in the configuration shown in FIG. 4E). In addition, the shape of the first and second trapping portions 173a, 173b prevents the engagement portion(s) from unintentionally becoming dislodged from the respective trapping portion the during the injection or depressurisation processes (e.g. due to any vibrations that may arise during these processes) to further aid in keeping the container 200 safely secured to the locking head 170.

With reference to FIGS. 4B and 4E, the locking head 170 includes channels 173c, each of which leads to a respective track portion 173. The engagement portion of the container 200 is insertable into the track portion, and removable from the track portion via the channel 173c. The track portion of the engagement feature 173 includes a ramp portion 173e leading from the upright surface 173d of the second trapping portion 173b to the channel 173c. This ramp portion 173c facilitates a smooth insertion of the engagement portion 242 of the container 200 from the channel portion 173c to the second trapping portion 173b and a smooth removal of the engagement feature from the second trapping portion 173b to the channel portion 173c.

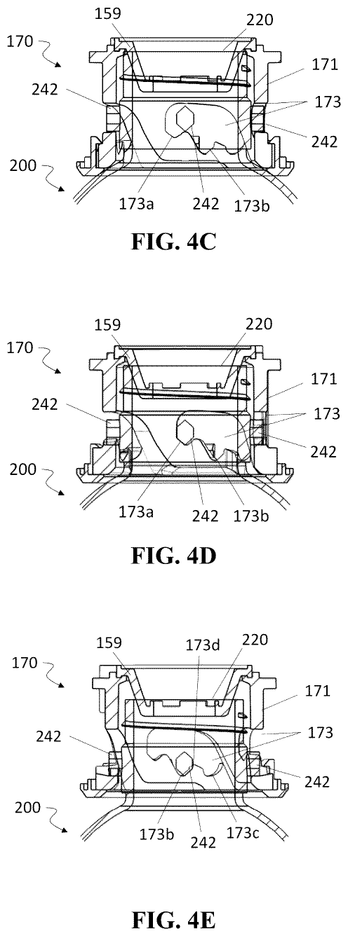

With reference to FIGS. 5A to 7B, the carbonation device includes a linkage (or a clutch mechanism). As previously described above, the tilt head 150 is tiltable relative to the spout portion 114 of the carbonation device between a first tilt head position and a second tilt head position by an angle θ (see FIG. 5D). The first tilt head position is a carbonation position corresponding to the ready orientation. The second tilt head position is a tilted position corresponding to an outward-facing orientation of the tilt head 150 for insertion or removal of the container with respect to the tilt head 150. The tilting functionality allows the user to tilt the tilt head 150 outwardly to easily and more naturally locate or remove the container with respect to the tilt 150, as previously described above). However, for safety reasons, the container should be returned to a vertically upright position prior to the infuser being activated to inject CO₂ into the container to carbonate the beverage contained therein. There is some risk that the container could unintentionally launch from the carbonation device, potentially in a direction of the user, if the container is not in a vertically upright position during the carbonation process. In this regard, the linkage is configurable to activate the infuser for carbonation only when the tilt head 150 is in the correct position for safe activation, being a ready orientation that corresponds to the vertically upright position of the container when held by the tilt head 150.

With reference to FIG. 5D, the enclosure 110 of the carbonation device 100 houses a cannister 300 that contains carbon dioxide that is used for carbonating the beverage. When the cannister 300 is depleted, the cannister 300 can be removed from the enclosure 110 and a new cannister can be installed in the enclosure 110. The cannister 300 has a release valve 140 installed at its mouth with a switch 142 that is activatable allow for carbon dioxide to be released from the cannister 300 via the release valve 140. The switch 142 is a pin or push switch or a button that allows for carbon dioxide to be released from the cannister 300 when pressed. The switch can be activated by the linkage only when the tilt head 150 is in the first tilt head position (corresponding to the container being in the ready orientation) and the handle 130 is operated by the user. The switch 142 requires a large force to activate. The force required to activate the switch 142 is provided by the handle 130 and transferred to the switch 142 via the linkage, only when the container is in the ready orientation. In particular, the user would only need to apply a small force to the handle that would result in a sufficiently large force being applied on the switch 142 to thereby activate it. The force that is applied by the user to the handle 130 and the force that is applied by the linkage to the switch 142 are in a ratio of about 1 to up to 10, preferably about 1 to at least 4, further preferably about 1 to 6 The carbon dioxide that is released from the cannister 300 is communicated to the container via the infusion line and infuser previously described above with reference to FIGS. 1A and 1B. In the event that the tilt head is in the second tilt head position and the handle is operated, the switch would not be activated such that no carbon dioxide is released from the cannister 300.

The linkage links the handle 130 and the tilt head 150 with the switch 142. In this regard, the linkage has a first part that links to the tilt head and a second part that links to the switch 142 for the cannister 300. The two parts intersect each other at a point at which the second portion of the handle (previously described above) is located. The first part of the linkage is used for checking when the tilt head is in a first tilt head position and would allow for the handle, when operated, to actuate the second part of the linkage when the tilt head is in the first tilt head position. The linkage is configurable in (1) a first configuration, when the tilt head is in the first tilt head position, in which operation of the handle 130 pivots about the first portion (and the first pivot axis therethrough) and transfers load applied to the handle 130 via the linkage to activate the switch 142 to carbonate the beverage in the container; and (2) a second configuration, when the tilt head 150 is in the second tilt head position, in which any load applied to the handle 130 instead forces the handle 130 to pivot about the second portion (and the second pivot axis therethrough) and the first portion of the handle 130 to move from its first position to the second position such that no load is transferred via the linkage to the switch 142. In this way, operation of the handle 130 when the tilt head 150 is in the second tilt head position (corresponding to the bottle being in an loading orientation) does not activate the switch 142 for the cannister 300.

With reference to FIG. 5D, the tilt head 150 includes an engagement feature (e.g. a recess) 157 on an outer wall portion of the tilt head 150. The linkage includes a piston portion 121 that is moveable upon operation of the handle 130. The piston portion 121 is engageable with the engagement feature 157 of the tilt head 150 only when the tilt head 150 is in the first tilt head position and the handle 130 is operated. The tilt head 150 is tiltable between the first tilt head position and the second tilt head position by an angle θ previously described above.

As previously described above and with reference to FIG. 5F, the handle 130 has a first portion 134a about which the handle 130 is pivotable about the first pivot axis and a second portion 134b about which the handle 130 is pivotable about the second pivot axis. The handle 130 is pivotably coupled at the first portion 134a to the enclosure 110 and pivotably coupled at the second portion 134b to the linkage in the enclosure 110. The enclosure 110 has a slot 118 along which said first portion 134a of the handle 130 is moveable between a first position and a second position when the handle 130 pivots about the second pivot axis. The slot 118 has a first channel portion for receiving the first portion 134a of the handle 130 when in the first position, a second channel portion for receiving the first portion 134a of the handle 130 when in the second position, and an intermediate channel portion between the first and second channel portions defining a narrow passage to trap the first portion 134a in the first channel portion such that the first portion 134a would only be able to escape the first channel portion via the intermediate passage when a sufficient force is applied to the first portion 134a upon actuation of the handle 130. This sufficient force corresponds to a force that would be applied when the handle 130 is operated and when the second portion 134b of the handle 130 is fixed, such that the handle 130 pivots about the second portion 134b. In the preferred example, the slot 118 is a kidney-bean shaped slot. In the preferred example, the second portion 134b of the handle 130 is pivotably coupled to a portion of the linkage via a ball-and-socket configuration. The first portion 134a of the handle 130 is normally in the first location. In FIG. 5C, the first pivot axis passes through a first pivot point P1 and the second pivot axis of the handle passes through a second pivot point P2.

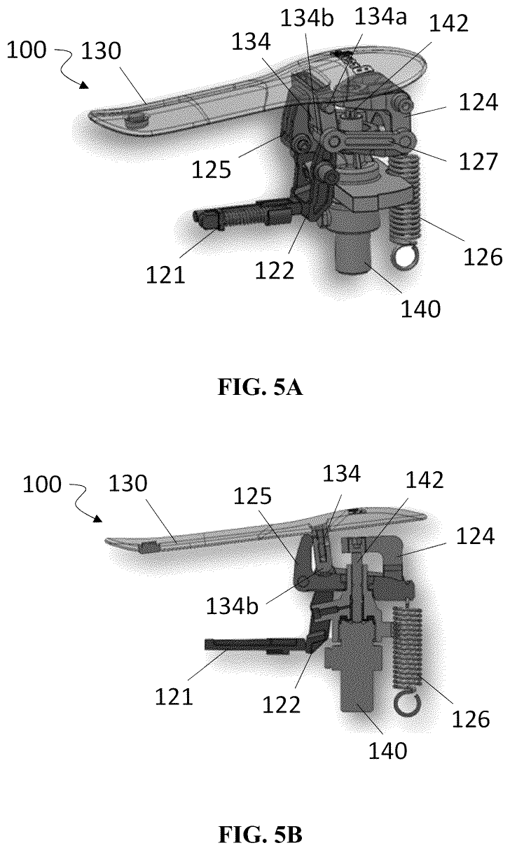

When the tilt head 150 is in the first tilt head position (as shown in FIGS. 6A and 6B), the engagement feature 157 is aligned for engagement by the piston portion 121. The engagement of the piston portion 121 with the engagement feature 157 of the tilt head 150 allows for activation of the switch 142. In particular, the movement of the piston portion 121 towards the engagement feature 157 when the handle 130 is operated toward the second handle position (the ‘on’ position) causes the second portion 134b of the handle 130 to move rearwardly, while the handle 130 pivots about the first portion 134a, thereby causing the linkage to activate the switch 142.

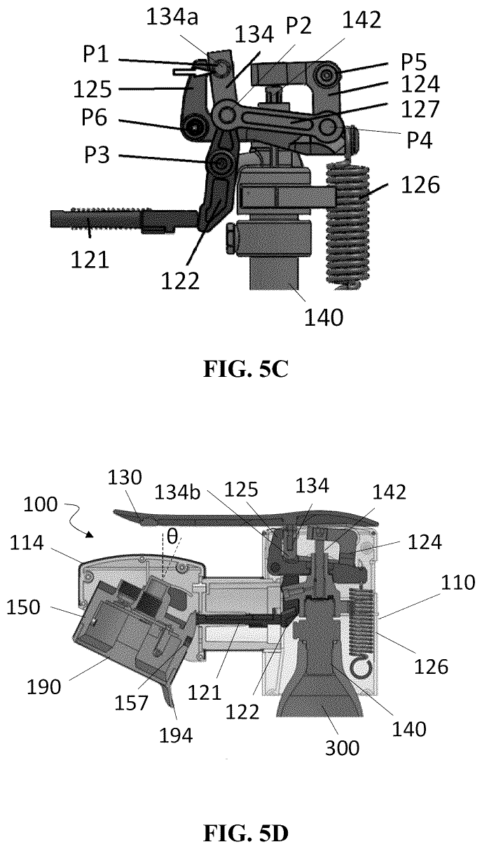

On the other hand, when the tilt head 150 is in the second position (as shown in FIGS. 7A and 7B), the engagement feature 157 is no longer aligned with the piston portion 121. In this configuration, the piston portion 121 is not able to move towards the tilt head 150. An outer wall portion of the tilt head 150 blocks movement of the piston portion 121 when the tilt head 150 is in the second tilt head position. In particular, because the linkage is inhibited moving towards the engagement feature 157 when the handle 130 is operated toward the second handle position (the ‘on’ position), the second portion 134b of the handle 130 would be fixed in place or remain stationary with respect to the enclosure 110 such that the handle would pivot about the second portion 134b and the switch 142 is not activated by the linkage. In this configuration, the first portion 134a of the handle 130 would move along the slot 118 from the first position to the second position.

With reference to FIGS. 5A to 5F, the linkage includes the following features:

A first link portion (or wishbone member) 122 pivotable about a third pivot point P3, pivotably connected to the piston portion 121 and pivotably connected at a second pivot point P2 to the finger member 134. A pivoting of the first link portion 122 about the third pivot point P3 causes a linear movement of the piston portion 121 with respect to the tilt head 150. The first link portion 122 has a pair of spaced apart arm portions that are coupled to the finger member 134 of the handle 130 at its second portion 134b in a ball-and-socket configuration. The first link portion 122 would move about the third pivot point P3 only when the handle is operated towards the ‘on’ position and the tilt head 150 is in the first tilt head position in which the engagement feature 157 (i.e. the recess) of the tilt head 150 would be aligned with the piston portion 121, which would allow the piston portion 121 to move into engagement with the tilt head 150. Otherwise, if the tilt head 150 is in the second tilt head position, the piston portion 121 would not be able to move towards the tilt head 150 thereby the first link portion 122 would remain substantially stationary and the other link portions of the linkage, which will be described below, would also remain substantially stationary. A pivoting movement of the finger portion 134 about the first pivot point P1 and a pivoting movement of the first link member 122 about the third pivot point P3 (when the tilt head is in the first tilt head position) causes a pivoting about the second pivot point P2 (where the second portion 134b of the handle 130 is located) that consequentially moves the second portion 134b of the handle 130 to actuate the other link portions of the linkage to activate the switch 142.

A second link portion 127 connected to the second pivot point P2. The second link portion 127 moves in unison with the second pivot point P2 where the second portion 134b of the handle 130 is located upon the pivoting movements of both the handle and the first link portion 122.

A third link portion 124 pivotably connected at a fourth pivot point P4 to the second link portion 127 and having a fifth pivot point P5 about which the third link portion 124 is pivotable. The third link portion 124 has an actuation portion for activating the switch 142 of the infuser. In particular, the actuation portion contacts the switch 142 and presses the switch 142 when the piston portion 121 engages the tilt head 150 and the handle 130 is operated to an ‘on’ position. A movement of the second link portion 127 rearwardly causes the third link portion 124 to pivot about the fifth pivot point P5, which in turn causes the actuation portion of the third link portion 124 to move downwardly to press the switch 142 to activate the infuser.

A fourth link portion (L-member) 125 having a portion that abuts the finger member 134 of the handle and being pivotable about a sixth pivot point P6. A spring 126 is connected to the fourth link portion 125 for biasing the fourth link portion to return to a rest position. The spring is attached at one end to the enclosure 110 and attached at the other end to the sixth link portion 125. The spring has a tension force of between about 40N and 120N, preferably between about 50N to about 100N, further preferably about 70N. The fourth link portion 125, when biased in the rest position, applies enough force on the finger portion 134 of the handle to keep the first portion 134a of the finger portion 134 in the respective first position when the handle is operated towards the on position and the tilt head 150 is in the first tilt head position. In addition, when the handle 130 is operated towards the ‘on’ position and when the tilt head 150 is in the second tilt head position (such that the piston portion 121 is not aligned with the engagement feature 157 in the tilt head), the second pivot point P2 would remain substantially stationary (thereby the second and third link portions 124, 127 would also remain substantially stationary), which causes the handle 130 to pivot about the second pivot point P2 and causes the first portion 134a of the finger member to move in the kidney-bean shaped slot from the first position to the second position as previously described while pushing against the fourth link portion 125 to cause the fourth link portion 125 to move about the sixth pivot point P6 against the biasing of the spring 126. When the user releases the handle 130 from the ‘on’ position, the spring acts on the fourth link portion 125 to return it to a rest position which in turn pushes against the finger member 134 and causes the handle 134 to return to the ‘off’ position and the first portion 134a of the finger member to return to the first position.

In the description above, the first pivot point P1, third pivot point P3, the fifth pivot point P5, and the sixth pivot point P6 are fixed relative to the enclosure 110 of the carbonation device, while the second pivot point P2 and the fourth pivot point are floating with respect to the enclosure 110.

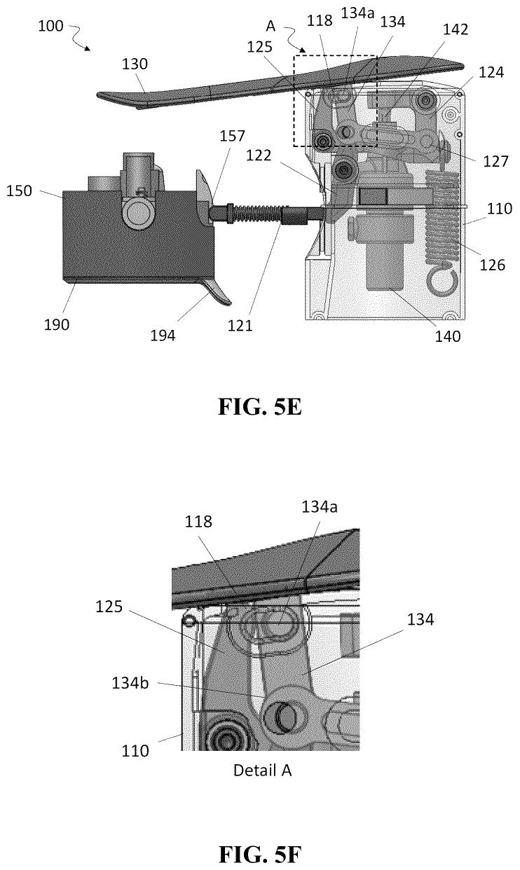

Moving now to FIGS. 8 to 17, which show a second embodiment of a carbonation device 400 according to the present invention. The carbonation device 400 is substantially similar to the carbonation device 100, and will be discussed in terms of salient differences to the carbonation device 100. Features that are not discussed in further detail are interchangeable with those discussed in relation to the carbonation device 100. The features of each carbonation device 400, 100 are further interchangeable and could be combined in other permutations than those explicitly discussed here.

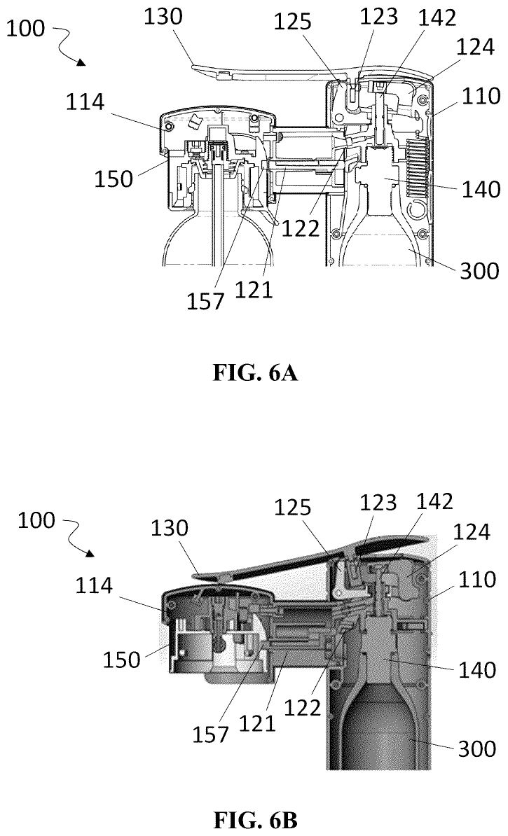

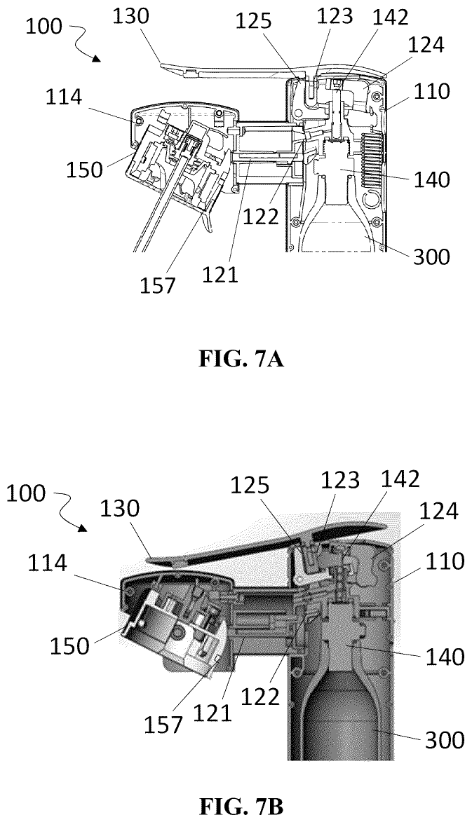

As shown in FIG. 8, the carbonation device 400 includes a head portion 414b communicable with a mouth portion 414c of a container 200. The head portion 414b is adjustable between a first head position, as shown in FIG. 9, and a second head position, as shown in FIG. 10. Returning to FIG. 8, the carbonation device 400 includes an infuser device 300, sometimes referred to as a cannister 300, having a switch 442 that is selectively activatable to release carbon dioxide for injection into the container 200 via the head portion 414b.

The carbonation device 400 further includes a handle 430 that is operable by a user for activating the switch 442 of the infuser device 300. The carbonation device 400 also includes a linkage 460 linking the head portion 414b with the switch 442. In this embodiment, the linkage 460 indirectly links the head portion 414b with the switch 442, such that there is a causal connection between movement of the head portion 414b and operation of the switch 442, but there may not be a permanent mechanical connection between the head portion 414b and the switch 442. The linkage 460 is configurable in a first configuration, when the head portion 414b is in the first head position, as shown in FIG. 9, in which operation of the handle 430 operates the switch 442 to carbonate the beverage in the container 200. The linkage 460 is also configurable in a second configuration, when the head portion 414b is in the second head position, as shown in FIG. 10, in which operation of the handle 430 does not activate the switch 442.

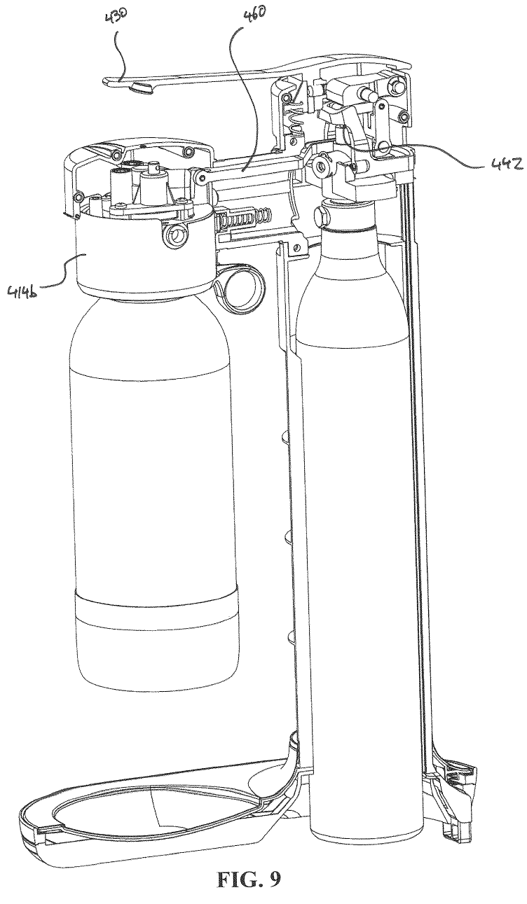

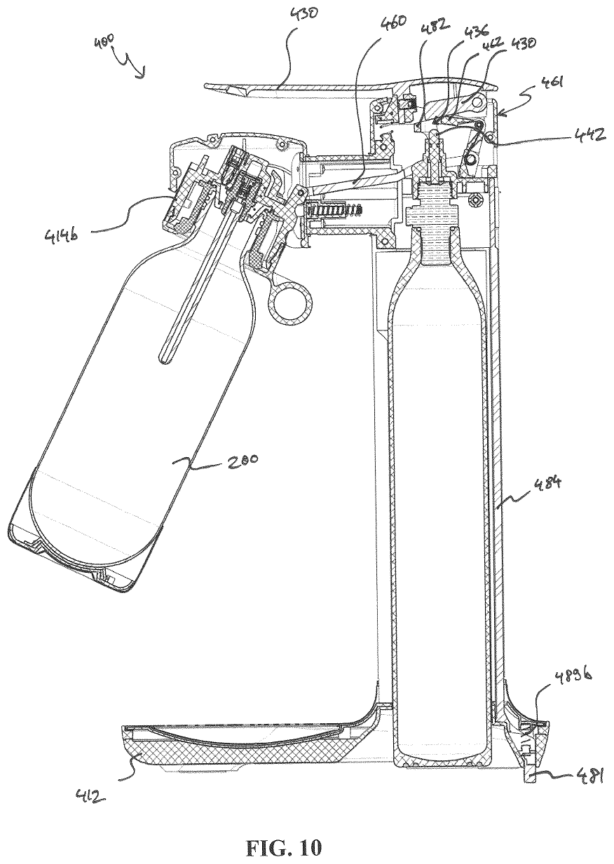

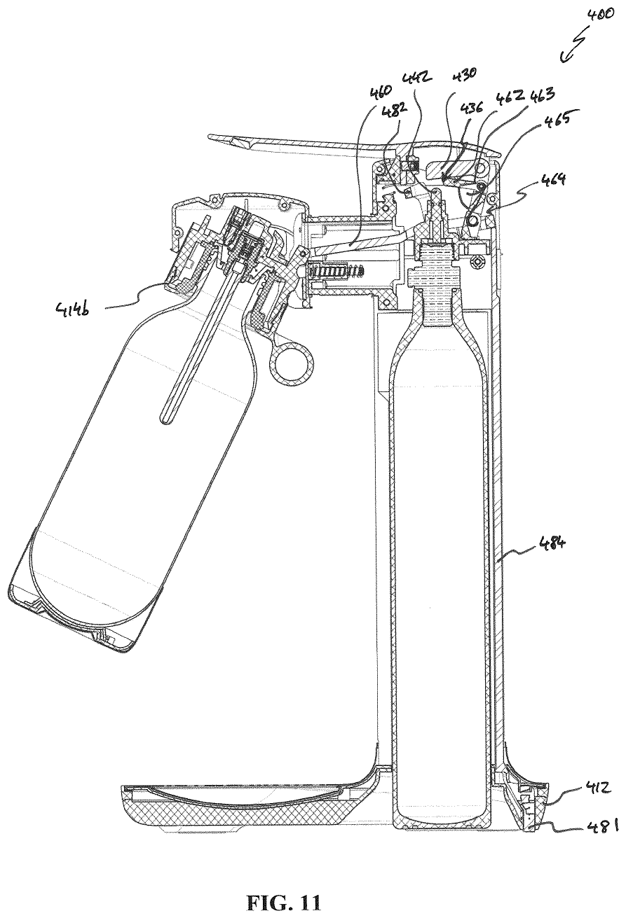

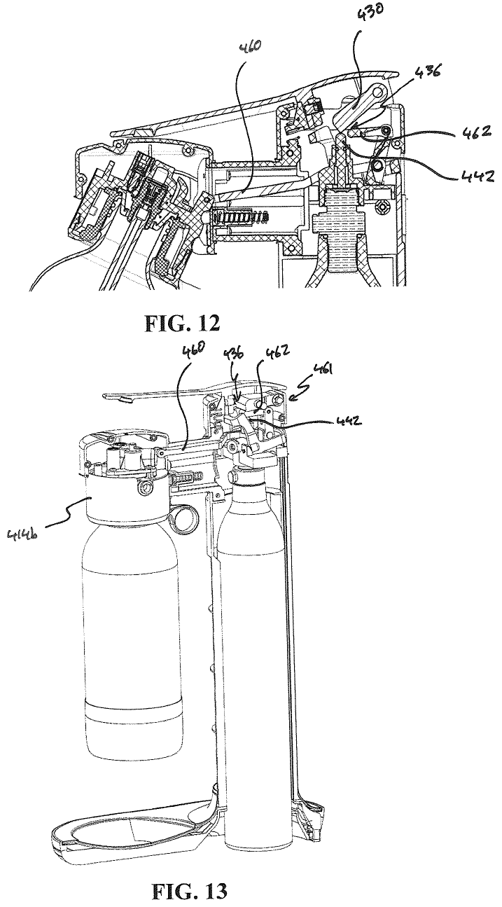

As shown in FIG. 10, the handle 430 and the switch 442 are configured such that a gap 436 exists between the handle 430 and the switch 442. The linkage 460 includes a transmission member 461 having a protrusion 462 adapted to, when the linkage 460 is in the first configuration as shown in FIGS. 13 and 14, be positioned in the gap 436 such that operation of the handle 430 operates the switch 442, as shown in FIG. 15. As shown in FIG. 10, when the linkage 460 is in the second position, the transmission member 461 has moved such that the protrusion 462 is outside the gap 436 such that operation of the handle 430 does not activate the switch 442, because force from the handle 430 cannot be transferred to the switch 442 across the gap 436, as demonstrated in FIG. 12.

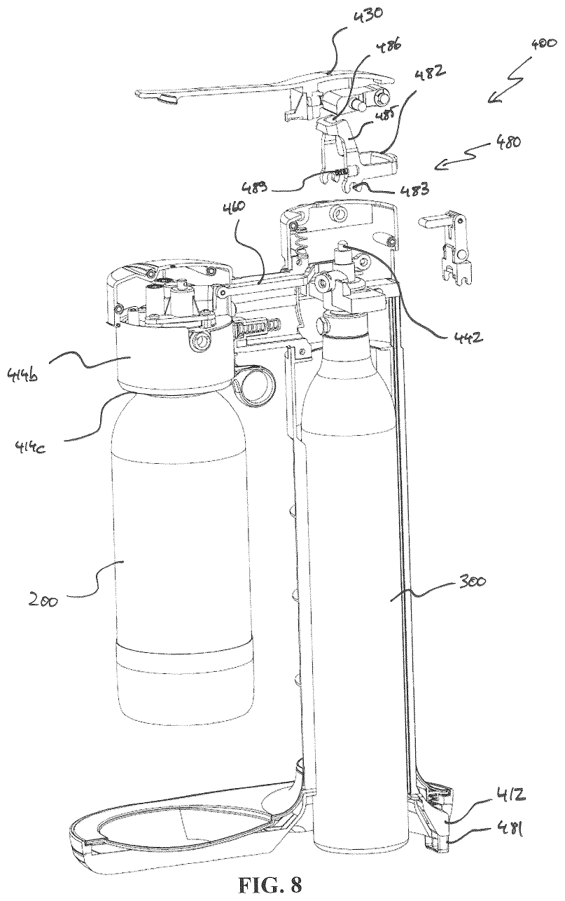

As shown in FIG. 11, the transmission member 461 has a body 464, and the protrusion 462 is pivotally mounted to the body 464, such that an angle 465 between the protrusion 462 and the body 464 changes between the first and second configurations of the linkage 460. The protrusion 462 is biased toward the body 464 using a bias member 463. As a result, when the linkage 460 is moved from the second configuration to the first configuration, the protrusion 462 remains in sliding contact with the handle 430, so that the protrusion 462 does not jam against the switch 442, or inadvertently operate the switch 442.

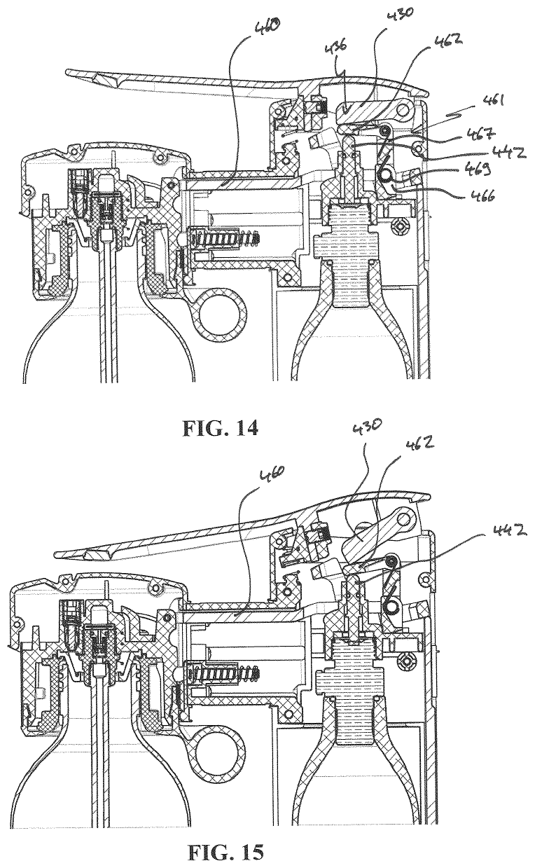

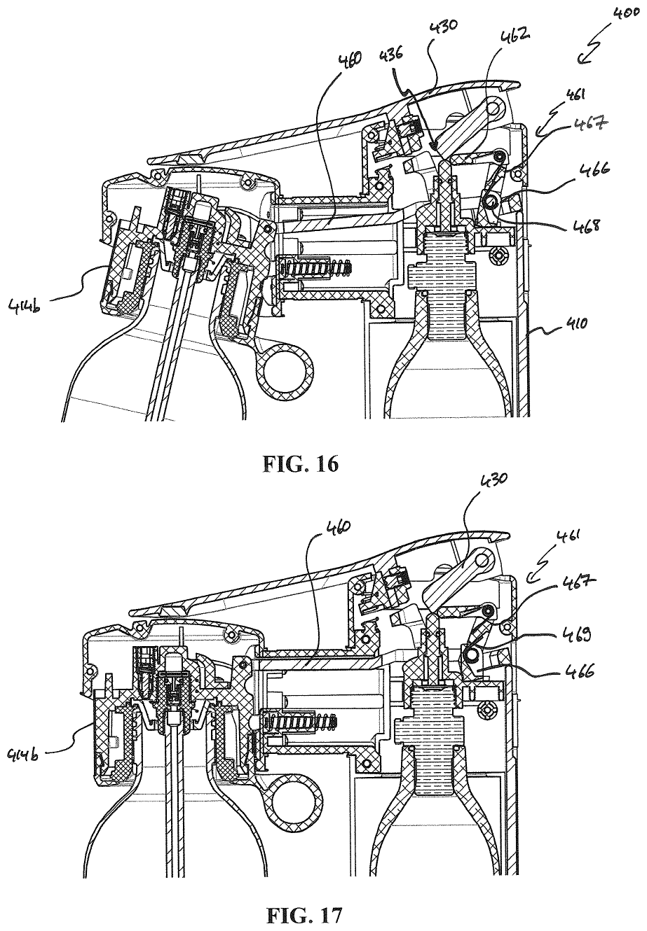

Moving now to FIG. 16, the transmission member 461 includes a first member 466 and a second member 467. The first member 466 is pivotally connected at one end to an enclosure 410 of the carbonation device 400, and pivotally connected at a second end to a pivot 468. The second member 467 is pivotally connected at one end to the pivot 468, and at a second end pivotally to the protrusion 462. As a result, if motion of the linkage 460 is resisted by the transmission member 461, for example as seen in FIG. 16 where operation of the handle 430 blocks the gap 436 that the protrusion 462 would ordinarily be urged toward by the movement of the head portion 414b to the first position, the first member 466 and second member 467 are moveable about the pivot 468 to absorb the movement of the linkage 460 without movement of the protrusion 462, to allow the linkage 460 to complete the motion, as seen in FIG. 17.

As also shown in FIG. 17, the first member 466 and the second member 467 are biased towards a rest state, shown in FIG. 14, using a bias member 469. In this way, once the resistance of the transmission member 461 to the motion of the linkage 460 is removed, for example by releasing the handle 430, the first member 466 and second member 467 revert to the rest state, as shown in FIG. 14. As a result, the protrusion 462 is positioned in the gap 436. It is particularly helpful, in this scenario, that the protrusion 462 is biased toward the handle 430 to avoid jamming of the motion of the first member 466 and the second member 467 under the force of the bias member 469, which could be a lower force than that applied by a user to the head portion 414b to move to the first position.

Returning to FIG. 8, the carbonation device 400 further includes a positional safety mechanism 480. The positional safety mechanism 480 includes a tab 481 protruding from a base 412, or foot portion, of the carbonation device 400. The tab 481 is positioned such that, when the carbonation device 400 is positioned with the with the foot portion 412 on a surface (not shown), the tab 481 moves from a blocking position, shown in FIG. 10, to a safe position, shown in FIG. 11. The position safety mechanism 480 may also include a blocking member 482 that is preferably pivotally connected to the enclosure 410 using a pivot 483. The blocking member 482 is moveable, preferably by pivoting about the pivot 483, between a blocking position, shown in FIG. 10, and a safe position, shown in FIG. 11. In the blocking position, the blocking member 482 abuts the handle 430 and causes the handle 430 to not be operable to activate the switch 442. In the safe position, the blocking member 482 has pivoted out of the range of motion of the handle 430 allowing the handle 430 to be operable to activate the switch 442. The position safety mechanism 480 also includes a second linkage 484 to link the tab 481 with the blocking member 482 such that motion of the tab 481 is linked to motion of the blocking member 482. Preferably, when the tab 481 is in the blocking position, the blocking member 482 is also in the blocking position, and when the tab 481 is in the safe position, the blocking member 482 is also in the safe position.

The blocking member 481 preferably has a first arm 485 extending from the pivot 483 and is adapted to, in the blocking position, block movement of the handle 430 toward the switch 442. The first arm 485 may also include a recess 486 to allow the protrusion 462 of the transmission member 461 to be positioned in the gap 436 between the handle 430 and the switch 442. The width of the recess 486 is about the same as the width of the protrusion 481, while the width of the first arm 485 is greater than the width of the recess 486, and the width of the portion of the handle 430 that moves toward the switch 442 has a greater width than the recess 486. The blocking member 482 further includes a second arm 487 extending from the pivot 483 at an angle 488 to the first arm 485. The second arm 487 is connected to the second linkage 484 to pivotally move the blocking member 482 about the pivot 483 between the blocking and safe positions when the second linkage 484 is operated by the tab 481. Preferably, the blocking member 482 is biased toward the blocking position using a bias member 489. Preferably the tab 481 is also biased toward the blocking position using another bias member 489b.

Use of the carbonation device 400 will now be discussed.

Departing from the configuration of the carbonation device 400 in FIG. 10, wherein the head portion 414b is in the second position and has received the container 200 containing liquid to be carbonated. The tab 481 is in the blocking position and the linkage 460 is in the second position. Thus, the blocking member 482 prevents movement of the handle 430 towards the switch 442, and even if the handle 430 were to be moved, the protrusion 462 of the transmission member 461 is not positioned in the gap 436, therefore the handle 430 cannot actuate the switch 442.

Moving now to FIG. 11, wherein the carbonation device 400 has been located on a surface (not shown), pushing the tab 481 to the safe position, thereby, through the second linkage 484, moving the blocking member 482 to the safe position, allowing movement of the handle 430 toward the switch 442. However, the head portion 414b is still in the second position, meaning that the protrusion 462 is not in the gap 436, thus movement of the handle 430 does not operate the switch 442, as seen in FIG. 12.

Once the head portion 414b has been moved to the first position, as shown in FIG. 13, the linkage 460 has moved the transmission member 461 such that the protrusion 462 moves into the gap 436, as shown in FIG. 14, such that movement of the handle 430 operates the switch 442, as shown in FIG. 15.

In the event that the head portion 414b is moved to the first position while the handle 430 is held down, as shown in FIG. 16, the first member 466 and second member 467 of the body 464 of the transmission member 461 deflect, as shown in FIG. 17, to absorb the movement of the linkage 460, without causing damage to the components of the carbonation device 400. Once the handle 430 is released, the first member 466 and second member 467 move under the force of the bias member 469 back toward the rest position, thereby moving the protrusion 462 into the gap 436, resulting in the position shown in FIG. 14.

Integers:

| | |
|---|---|
| 100 | carbonation device |
| 110 | enclosure |
| 110a | aperture |
| 112 | base |
| 114a | shaft portion |
| 114b | head portion |
| 114c | mouth portion |
| 114d | projections |
| 114 | spout portion |
| 116 | channel |
| 118 | slot |
| 120 | infuser |
| 121 | piston portion |
| 122 | first link portion |
| 124 | third link portion |
| 125 | fourth link portion |
| 126 | spring |
| 127 | second link portion |
| 130 | handle |
| 132 | lever portion |
| 134 | finger member |
| 134a | first portion |
| 134b | second portion |
| 140 | release valve |
| 142 | switch |
| 150 | tilt head |
| 152 | safety pressure valve |
| 153 | recesses |
| 154 | safety pressure valve |
| 155 | apertures |
| 156 | safety pressure valve |
| 157 | engagement feature |
| 159 | tapered washer |
| 160 | linkage |
| 170 | locking head |
| 173 | engagement feature |
| 173a | first trapping portion |
| 173b | second trapping portion |
| 173c | channel |
| 173d | upright surface |
| 173e | ramp portion |
| 175 | apertures |
| 190 | skirt |
| 192 | ring-shaped body |
| 194 | tab portion |
| 200 | container |
| 220 | mouth portion |
| 240 | neck portion |
| 242 | engagement portions |
| 300 | cannister |
| 400 | carbonation device |
| 410 | enclosure |
| 414b | head portion |
| 414c | mouth portion |
| 430 | handle |
| 436 | gap |
| 442 | switch |
| 460 | linkage |
| 461 | transmission member |
| 462 | protrusion |
| 463 | bias member |
| 464 | body |
| 465 | angle |
| 466 | first member |
| 467 | second member |
| 468 | pivot |
| 469 | bias member |
| 480 | positional safety mechanism |
| 481 | tab |
| 482 | blocking member |
| 483 | pivot |
| 484 | second linkage |
| 485 | first arm |
| 486 | recess |
| 487 | second arm |
| 488 | angle |
| 489 | bias member |

1. A carbonation device for carbonating a beverage in a container, the carbonation device comprising:
a head portion for sealably receiving a mouth portion of the container, the head portion having an infuser that is operable to inject carbon dioxide into the container via the mouth of the container; and
an engagement feature with which the container can be configured to securably locate the container with respect to the head portion in:
an injection configuration in which the mouth portion of the container is substantially sealed with respect to the infuser so that the infuser can inject carbon dioxide into the container to carbonate the beverage in the container; and
a depressurisation configuration in which the mouth portion of the container is partially unsealed with respect to the infuser to allow for depressurization of the container.

2. The carbonation device of claim 1, wherein the engagement feature includes at least one track portion that is engageable by a respective lug of the container, the track portion including:
a first trapping portion that corresponds to the injection configuration when the respective lug of the container is located therein; and
a second trapping portion that corresponds to the depressurisation configuration when the respective lug of the container is located therein.

3. The carbonation device of claim 2, wherein the first trapping portion has a higher elevation compared to the second trapping portion with respect to the head portion.

4. The carbonation device of claim 2 or 3, wherein the first trapping portion and the second trapping portion respectively includes a crevice or valley portion in which the lug is trappable.

5. The carbonation device of any one of claims 2 to 4, wherein at least one of the first trapping portion and the second trapping portion has at least one bearing surface against which the lug bears when in the respective injection or depressurisation configuration.

6. The carbonation device of claim 5, wherein the bearing surface is a vertically upright wall portion.

7. The carbonation device of any one of claims 1 to 6, wherein the carbonation device includes a collar for embracing a neck of the container, the collar including the engagement feature.

8. The carbonation device of claim 7, wherein the collar includes a channel leading to the engagement feature, wherein the neck portion of the container has a lug that is insertable into, and removable from, the engagement feature via the channel.

9. A carbonation device for carbonating a beverage in a container, the carbonation device comprising:
a head portion communicable with a mouth portion of the container, the head portion being adjustable between a first head position and a second head position;
an infuser device having a switch that is selectively activatable to release carbon dioxide for injection into the container via the head portion;
a handle that is operable by a user for activating the switch of the infuser device; and
a linkage linking the head portion with the switch, wherein the linkage is configurable in a first configuration, when the head portion is in the first head position, in which
operation of the handle activates the switch to carbonate the beverage in the container; and
a second configuration, when the head portion is in the second head position, in which operation of the handle does not activate the switch.

10. The carbonation device of claim 9, wherein the head portion is tiltable between the first head position to the second head position by an angle of at least 5°, or at least 10°, or at least 20°, or up to about 30°, or up to about 40°, or up to about 50°, or preferably about 26°.

11. The carbonation device of claim 9 or 10, wherein the head portion includes a tab portion that is manipulatable by a user to adjust the head portion from the first head position to the second head position and/or from the second head position to the first head position.

12. The carbonation device of any one of claims 9 to 11, wherein the handle has a first portion defining a first pivot point about which the handle is pivotable when the head portion is in the first position and a second portion defining a second pivot point about which the handle is pivotable when the head portion is in the second position, wherein when the handle pivots about the second portion, the first portion moves from a first position to a second position and when the handle pivots about the first portion, the second portion actuates the linkage to actuate the switch.

13. The carbonation device of claim 12, wherein the first portion is moveable between the first position and the second position in a slot, the slot having a first channel portion for receiving the first portion in the first position, a second channel portion for receiving the first portion in the second position, and an intermediate channel portion between the first and second channel portions defining a narrow passage to trap the first portion in the first channel portion.

14. The carbonation device of any one of claims 9 to 13, wherein:
the linkage includes a piston portion that is moveable upon operation of the handle;
the head portion includes an engagement feature that is engageable with the piston portion of the linkage only when the head portion is in the first position and the handle is operated; and
the engagement of the piston portion with the engagement feature of the head portion allows for activation of the switch.

15. The carbonation device of claim 14, wherein the linkage includes:
a first link portion pivotable about a third pivot point, pivotably connected to the piston portion and pivotably connected at the second pivot point to the handle;
a second link portion connected to the second pivot point; and
a third link portion pivotably connected at a fourth pivot point to the second link portion and having a fifth pivot point about which the third link portion is pivotable, the third link portion having an actuation portion for activating the switch of the infuser;
wherein operation of the handle when the piston portion is aligned with the engagement feature causes the handle to pivot about the first pivot point and the second link portion to pivot about the third pivot point, which causes a translational movement of the second link portion, which in turn causes the third link portion to pivot about the fifth pivot point to cause the actuation portion of the third link portion to active the switch, and
wherein operation of the handle when the piston portion is not aligned with the engagement feature causes the handle to pivot about the second pivot point and the second link portion to remain stationary such that the switch is not activated by the actuation portion.

16. The carbonation device of claim 15, wherein the linkage further includes:
a fourth link portion having a portion that abuts the handle and being pivotable about a sixth pivot point, the fourth link portion being biased to return to a rest position;
wherein operation of the handle when the piston portion is not aligned with the engagement feature causes:
the handle to push against the fourth link portion thereby displacing it from its rest position such that the handle and sixth portion move in unison about their respective first and sixth pivot points; and
when the handle is released, biasing acting on the fourth link portion returns the fourth link portion to its rest position which returns the handle to an off position.

17. The carbonation device of any one of claims 9 to 16, wherein the first head position corresponds to a position in which the container is held by the head portion in a substantially vertically upright position.

18. The carbonation device of any one of claims 9 to 17, wherein the linkage includes a transmission member, the transmission member having a protrusion adapted to, when the linkage is in the first configuration, be positioned in a gap between the handle and the switch such that operation of the handle activates the switch, and, when the linkage is in the second configuration, be positioned outside the gap between the handle and the switch such that operation of the handle does not activate the switch.

19. The carbonation device of claim 18, wherein the transmission member has a body, and the protrusion is pivotally mounted to the body, such that an angle between the protrusion and the body changes between the first and second configuration of the linkage.

20. The carbonation device of claim 19, wherein the protrusion is biased toward the handle such that when the linkage is moved from the second configuration to the first configuration, the protrusion remains in sliding contact with the handle during the movement.

21. The carbonation device of claim 18, wherein the transmission member has a body, and the body includes a first member and a second member, the first and second members being pivotally connected using a pivot, and the linkage connects to the body at the pivot, such that if motion of the linkage is resisted by the transmission member, the first and second members are movable about the pivot to allow the linkage to complete the motion.

22. The carbonation device of claim 21, wherein the first and second members are biased towards a rest state such that, once the resistance of the transmission member to the motion of the linkage is removed, the first and second members revert to the rest state.

23. The carbonation device of claim 21, wherein the rest state is configured such that, when the linkage is in the first configuration, the protrusion is positioned in the gap between the handle and the switch.

24. The carbonation device of any one of claims 9 to 23, wherein the carbonation device further includes a positional safety mechanism, the positional safety mechanism including:
a tab protruding from a foot portion of the carbonation device such that, when the carbonation device is position with the foot portion on a surface, the tab moves from a blocking position to a safe position;
a blocking member moveable between a blocking position, wherein the handle is not operable to activate the switch, and a safe position, wherein the handle is operable to activate the switch;
a second linkage to link the tab with the blocking member such that:
when the tab is in the blocking position, the blocking member is in the blocking position, and
when the tab is in the safe position, the blocking member is in the safe position.

25. The carbonation device of claim 24, wherein the blocking member is mounted using a pivot and includes a first arm extending from the pivot adapted to, in the blocking position, block movement of the handle toward the switch.

26. The carbonation device of claim 25, when dependent from claim 18, wherein the first arm includes a recess to allow the protrusion of the transmission member to be positioned in the gap between the handle and the switch.

27. The carbonation device of any one of claims 24 to 26, wherein the blocking member includes a second arm extending from the pivot at an angle to the first arm, the second arm being connected to the second linkage to pivotally move the blocking member between the blocking and safe positions.

28. The carbonation device of any one of claims 24 to 27, wherein the blocking member is biased toward the blocking position.

29. A container to contain beverage to be carbonated with the carbonation device of any one of claims 1 to 28, the container having a mouth portion and an engagement feature.

30. The container of claim 29, including at least one lug for engaging the engagement feature of the carbonation device.

31. The container of claim 30, wherein the at least one lug has a hexagon cross-sectional profile.

32. A carbonation assembly including:
the container of any one of claims 29 to 31; and
the carbonation assembly of any one of claims 1 to 28.
